(19) United States
(12) Patent Application Publication
(10) Pub. No.: US 2016/0180422 A1
(43) Pub. Date: Jun. 23, 2016

(54) LINKING OPEN OFFERS AND NEGOTIATION HISTORY

(71) Applicant: Arun Sharma, Santa Clara, CA (US)

(72) Inventor: Arun Sharma, Santa Clara, CA (US)

(21) Appl. No.: 14/582,044

(22) Filed: Dec. 23, 2014

(51) Int. Cl. G06Q 30/06

(52) U.S. Cl. CPC G06Q 30/0613; G06Q 30/0611

(57) ABSTRACT

Systems and methods are presented for linking open offers and negotiation history of a terminated transaction to a newly listed transaction. In some embodiments, the system presents a first item listing including at least a portion of a first set of data indicative of a product. The system receives interaction data indicative of a user interacting with the first item listing and associates the interaction data with the first item listing. The interaction data includes an offer of a user for purchase of a product. The system terminates the first item listing based on a predetermined time period and generates a second item listing including the portion of the first set of data included in the first item listing and the interaction data associated with the first item listing.

### TECHNICAL FIELD

The subject matter disclosed herein generally relates to the processing of data. Specifically, the present disclosure addresses systems and methods to link open offers and negotiation history from a terminated transaction to a newly listed transaction.

### BACKGROUND

Items posted on auction websites, sale websites, and publication systems can be time delimited. These time delimited item postings can be removed after a predetermined period of time. When item postings are removed, users of the websites or publication systems who are interested in these item postings may encounter difficulty in finding a similar product or a re-posting of the same item. Further users who have engaged in a negotiation for the item, subject to the time limitation, may lose progress gained in the negotiations when the item posting is removed due to the predetermined period of time elapsing. The loss of progress in negotiations can result in a loss of a sale to the vendor posting the item for sale.

### BRIEF DESCRIPTION OF THE DRAWINGS

Some embodiments are illustrated by way of example and not limitation in the figures of the accompanying drawings.

FIG. 1 is a network diagram illustrating a network environment suitable for linking open offers and negotiation history from a terminated transaction to a newly listed transaction, according to some example embodiments.

FIG. 2 is a block diagram illustrating components of a server machine suitable for linking open offers and negotiation history from a terminated transaction to a newly listed transaction, according to some example embodiments.

FIG. 3 is a flowchart illustrating operations of a device in performing a method of terminating a transaction and linking open offers and negotiation history of the terminated transaction to a newly listed transaction, according to some example embodiments.

FIG. 4 is a flowchart illustrating operations of a device performing a method of terminating a transaction and linking open offers and negotiation history of the terminated transaction to a newly listed transaction, according to some example embodiments.

FIG. 5 is a flowchart illustrating operations of a device performing a method of terminating a transaction and linking open offers and negotiation history of the terminated transaction to a newly listed transaction, according to some example embodiments.

FIG. 6 is a block diagram illustrating components of a machine, according to some example embodiments, able to read instructions from a machine-readable medium and perform any one or more of the methodologies discussed herein.

FIG. 7 is a block diagram illustrating components of a mobile device, according to some example embodiments, able to read instructions from a machine-readable medium and perform any one or more of the methodologies discussed herein.

### DETAILED DESCRIPTION

Example methods and systems are directed to linking open offers and negotiation history of a terminated transaction to a newly listed transaction. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

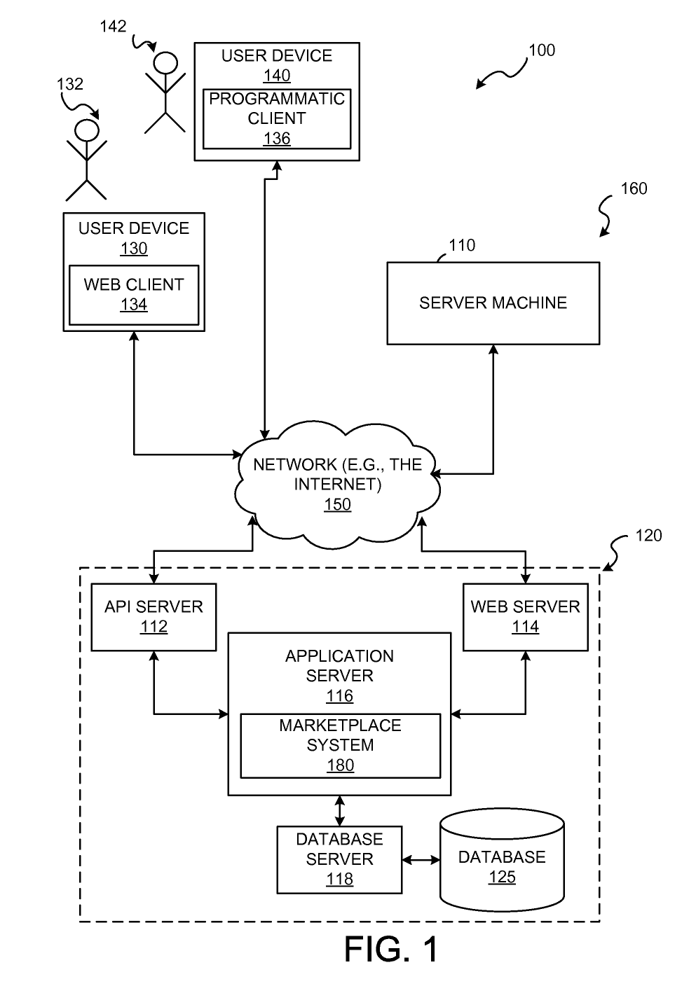

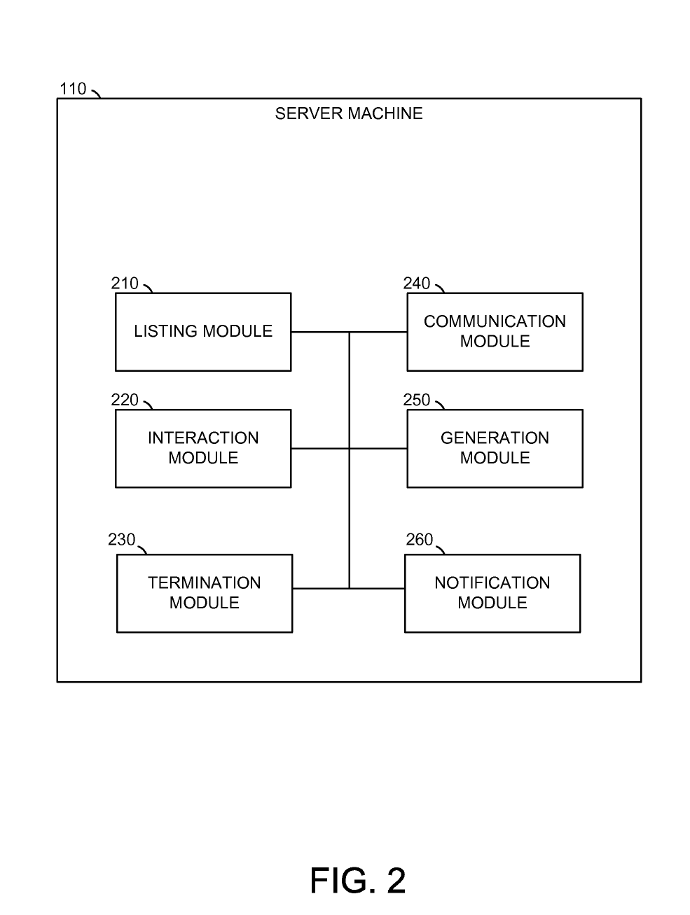

FIG. 1 is a network diagram illustrating a network environment 100 suitable for linking open offers and negotiation history of the terminated transaction to a newly listed transaction, according to some example embodiments. The network environment 100 includes a offer linking system 110, a publication system 120, and devices 130 and 140, all communicatively coupled to each other via a network 150. The offer linking system 110, explained in more detail with reference to FIG. 2, can form all or part of a network-based system 160 configured to link open offers and negotiation history of a terminated transaction to a newly listed transaction.

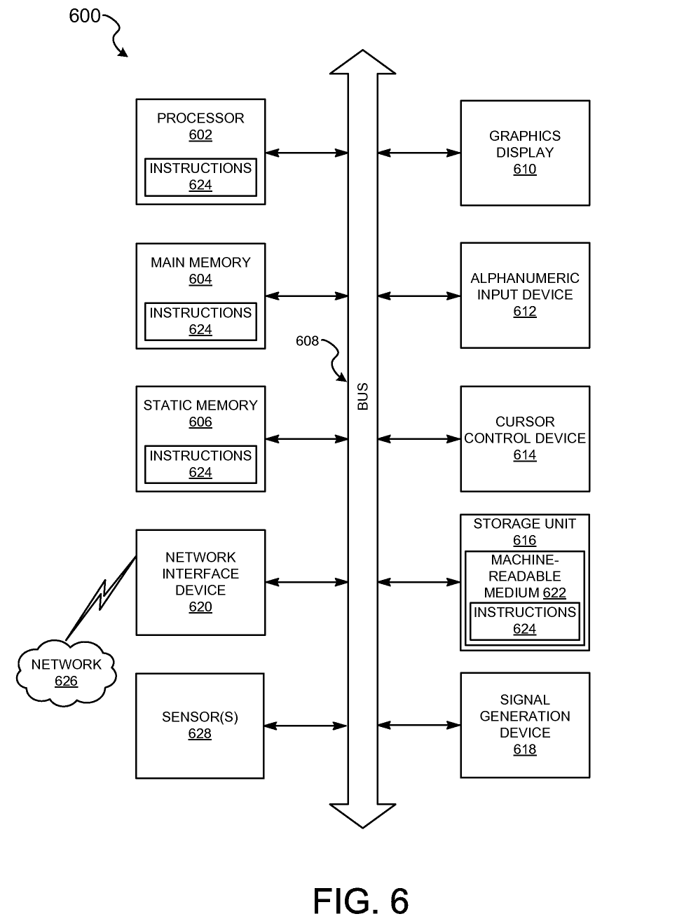

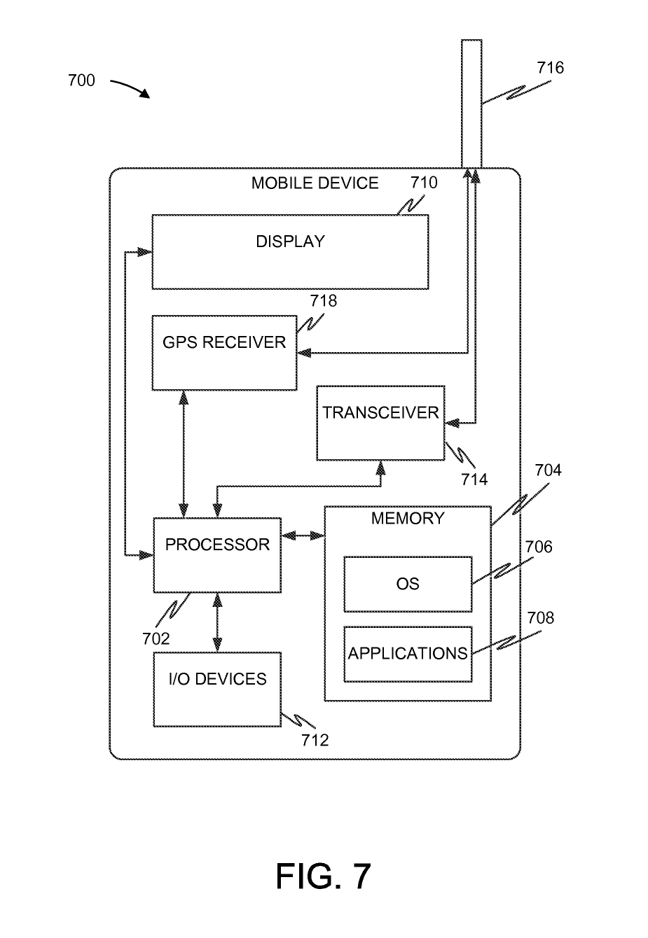

The publication system 120 is shown as including an API server 112, a web server 114, an application server 116, a database server 118, and the database 125. In some embodiments, the publication system 120 forms all or part of a network-based system 160 (e.g., a cloud-based server system configured to provide one or more services to the user devices 130 and 140). The offer linking system 110, the publication system 120, and the user devices 130 and 140 may each be implemented in a computer system, in whole or in part, as described below with respect to FIG. 6. In some embodiments, the devices 130 and 140 can be implemented in a mobile device, as described below with respect to FIG. 7. The publication system 120 can operate in conjunction with the offer linking system 110 to link user interactions with expired and time delimited publications on the publication system 120 to newly published time delimited publications relating to the expired publications. For example, where an expired publication has a time limit and some indication of a user interaction within an associated history, the publication system 120 and the offer linking system 110 can cooperate to link the user interaction to a new publication associated having the same or similar content as the expired publication.

The API server 112 provides a programmatic interface by which the user devices 130 and 140 can access the publication system 120. The API server 112 can be a machine, similar to that described with respect to FIG. 6, and can be implemented as a single API server 112 or a plurality of API servers 112. The API server 112 can contain software, processor executable instructions, or modules (containing one or more of software and hardware) enabling the API server 112 to provide the programmatic interface between the user devices 130 and 140 and the publication system 120.

The application server 116 may be implemented as a single application server 116 or a plurality of application servers 116. The application server 116, as shown, hosts one or more marketplace system 180, which comprises one or more modules or applications and which may be embodied as hardware, software, firmware, or any combination thereof. The application server 116 is, in turn, shown to be coupled to the database server 118 that facilitates access to one or more information storage repositories or databases, such as the database 125.

The marketplace system 180 provides a number of marketplace functions and services to users that interface with the network-based system 160. For example, the marketplace system 180 can provide information for products for sale or at auction facilitated by the marketplace system 180 and displayable on user devices 130 and 140. In some embodiments, the marketplace system 180 provides listings for products indicative of the information for products. The listings for products can be stored in the database 125 and may be searchable through the network-based system 160. The listings may include information indicative of a product, a condition of the product, terms of sale for the product, shipping information, a description of the product, a quantity, a purchase price of the product, a best offer option (i.e., an indication that a seller is willing to negotiate for a price below that of a listed purchase price), a reserve price, a current auction price, metadata associated with the product, metadata associated with coding for the listing, a bidding history, a best offer history (e.g., negotiation history containing offers and counter offers and parties associated with the offers and counter offers), and information indicative of product organization, such as titles, categories, category taxonomies, and product interrelations. The marketplace system 180 can also facilitate the purchase of products in the online marketplace that can later be delivered to buyers via shipping or any conventional method. The marketplace system 180 and the offer linking system 110 can cooperate to receive user interaction information associated with the listings of the marketplace system 180. Where the listings limited by a time span, expiring at the conclusion of the time span, the marketplace system 180 can create a new listing or relist (e.g., establish a new time span and new listing information) for an expired listing. The marketplace system 180 can interact with the offer linking system 110 to link the user interaction information associated with the expired listing to the new listing or relisted listing.

While the marketplace system 180 is shown in FIG. 1 to form a part of the network-based system 160, it will be appreciated that, in some embodiments, the marketplace system 180 may form part of a payment service that is separate and distinct from the network-based system 160. Further, while the client-server-based network environment 100 shown in FIG. 1 employs a user-server architecture, the present disclosure is not limited to such architecture, and may equally well find application in a distributed architecture system (e.g., peer-to-peer), for example. The various marketplace systems 180 may also be implemented as standalone software programs, which do not necessarily have networking capabilities. In some embodiments, the marketplace system 180 may form part of a payment service that is a part of the networked-based system 160.

The database server 118 is coupled to the database 125 and provides access to the database 125 for the user devices 130 and 140 and other aspects of the server machine 110. The database 125 can be a storage device that stores information related to products; documents; web sites; metadata relating to products, documents, or websites; and the like. In some instances the database server 118 and the database 125 can be accessed and modified by one or more system external to the marketplace system 180. For example, where the offer linking system 110 is a system external to the marketplace system 180, the offer linking system 110 can access the database server 118 and the database 125 to interact with listing data of the marketplace 180 contained therein to link user interaction information to one or more instances of listing data or one or more individual listings.

Also shown in FIG. 1 are users 132 and 142. One or both of the users 132 and 142 can be a human user (e.g., a human being), a machine user (e.g., a computer configured by a software program to interact with the user device 130), or any suitable combination thereof (e.g., a human assisted by a machine or a machine supervised by a human). The user 132 is not part of the network environment 100, but is associated with the user device 130 and is a user of the user device 130. For example, the user device 130 can be a desktop computer, a vehicle computer, a tablet computer, a navigational device, a portable media device, a smartphone, or a wearable device (e.g., a smart watch or smart glasses) belonging to the user 132. Likewise, the user 142 is not part of the network environment 100, but is associated with the user device 140. As an example, the user device 140 can be a desktop computer, a vehicle computer, a tablet computer, a navigational device, a portable media device, a smartphone, or a wearable device (e.g., a smart watch or smart glasses) belonging to the user 142.

The user device 130 contains a web client 134 which may access the various marketplace systems 180 and, in some cases, the server machine 110, via the web interface supported by the web server 114. Similarly, a programmatic client 136 is configured to access the various services and functions provided by the marketplace system 180 and, in some cases, the server machine 110, via the programmatic interface provided by the API server 112. The programmatic client 136 may, for example, perform batch-mode communications between the programmatic client 136 and the networked-based system 160 and the server machine 110.

Any of the machines, databases 125, or devices shown in FIG. 1 may be implemented in a general-purpose computer modified (e.g., configured or programmed) by software (e.g., one or more software modules) to be a special-purpose computer to perform one or more of the functions described herein for that machine, database 125, or device. For example, a computer system able to implement any one or more of the methodologies described herein is discussed below with respect to FIGS. 6 and 7. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 125, or devices illustrated in FIG. 1 may be combined into a single machine, and the functions described herein for any single machine, database 125, or device may be subdivided among multiple machines, databases 125, or devices.

The network 150 may be any network that enables communication between or among machines, databases 125, and devices (e.g., the server machine 110 and the user device 130). Accordingly, the network 150 can be a wired network, a wireless network (e.g., a mobile or cellular network), or any suitable combination thereof. The network 150 can include one or more portions that constitute a private network, a public network (e.g., the Internet), or any suitable combination thereof. Accordingly, the network 150 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 150 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

FIG. 2 is a block diagram illustrating components of the server machine 110, according to some example embodiments. The server machine 110 is shown as including a listing module 210, an interaction module 220, a termination module 230, a communication module 240, and a generation module 250 all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database 125, or device may be distributed across multiple machines, databases 125, or devices.

The listing module 210 can present item listings from the publication system 120. For example, the listing module 210 can cause presentation of a first item listing on a user interface of the user device 130 or 140. The listing can include at least a portion of a first set of data indicative of a product. The listing module 210 can associate item listings with profiles of the publication system 120. For example, the listing module 210 can associate the first item listing, a vendor profile and a user profile. In some embodiments, the listing module 210 can associate indications of interactions with profiles of the publication system 120. For example, the listing module 210 can associate the first item listing and a negotiation history with a vendor profile and a user profile who were parties to the negotiation.

The interaction module 220 can receive interaction data indicative of interactions with item listings on the publication system 120 and associate the interaction with the item listing. For example, the interaction module 220 can receive interaction data indicative of a user 132, 142 interacting with the first item listing and associate the interaction with the first item listing. In some embodiments, the interaction data can include an offer of a user 132, 142 for purchase of the product which is the subject of an item listing. The interaction module 220 can further be configured to transmit counter offers from a vendor in response to an offer from a user 132, 142. The interaction module 220 can also receive subsequent offers from a user 132, 142 in response to a counter offer from a vendor. In some example embodiments, the interaction data can also comprise designation of the first item listing on a watch list associated with a user profile. For example, the interaction module 220 can be configured to associate the first item listing with the user profile indicating interest by the user 132 associated with the user profile.

In some embodiments, the interaction module 220 can generate indications of interactions based on a single interaction of a predetermined interaction type or set of related interactions receive by the interaction module 220. For instance, the interaction module 220 can generate an a negotiation history based on receiving an offer, having a predetermined interaction type indicating an offer as a start of a negotiation. The interaction module 220 can associate the negotiation history with the item which is the subject of the negotiation. The interaction module 220 can generate status indicators indicative of the status of the negotiation history and associate the status indicator with the item listing. For example, the interaction module 220 can generate a completion indicator indicative of a status of the negotiation history, with the completion indicator indicating a completed negotiation history. A completion indicator can be indicative of an acceptance of an offer by one of a vendor and a user 132, 142; a rejection of an offer, by one of the vendor and the user 132, 142, which concludes the negotiation; or an incomplete negotiation history.

The termination module 230 can terminate item listings on the publication system 120 based on a predetermined period of time. In some embodiments, the termination module 230 can terminate item listings on the publication system 120 based on the completion indicator indicating a completed negotiation, where the completion indicator represents an acceptance of an offer.

The communication module 240 can enable communication for the server machine 110. For example, the communication module 240 can enable communication between the listing module 210, the interaction module 220, the termination module 230, the generation module 250, and the notification module 260. In some embodiments, the communication module 240 can enable communication between the server machine 110, the user device 130 or 140, and the publication system 120, as well as other systems capable of communicating with the server machine 110. In some embodiments, the communication module 240 can be implemented as hardware (e.g., a modem, a wireless networking card, a radio transceiver, or a communications transceiver such as a Bluetooth transceiver), software, or combinations of hardware and software.

The generation module 250 can generate item listings for the server machine 110 or the publication system 120. Where the generation module 250 generates an item listing subsequent to a previous item listing for the same product, the generation module 250 can include at least a portion of the previous item listing in the subsequent item listing. For example, the generation module 250 can generate a second item listing including a portion of a first set of data included in a first item listing and interaction data associated with the first item listing. In generating a second item listing, in some example embodiments, the generation module 250 can generate an item identification for a second item listing, associate data indicative of a first item listing with the item identification of the second item listing, and associate the interaction data with the item identification of the first item listing.

The notification module 260 can generate a notification indicative of the termination of an item listing. The notification can include a navigation link to a subsequent item listing, representing the product of the terminated item listing. The notification can include an indication of the interaction data of the terminated item listing. The notification module 260 can transmit the notification to a user 132 or 142 at a time proximate to the termination of the terminated item listing and the generation of the subsequent item listing. In some embodiments, the notification module 260 can transmit the notification prior to the termination of the terminated item listing. In some example embodiments, the notification module 260 can generate a notification indicative of the termination of the terminated item listing. In these embodiments, the notification can include a navigation link to the terminated item listing and an indication of the interaction data. The notification module 260 can transmit the notification prior to the termination of the terminated item listing.

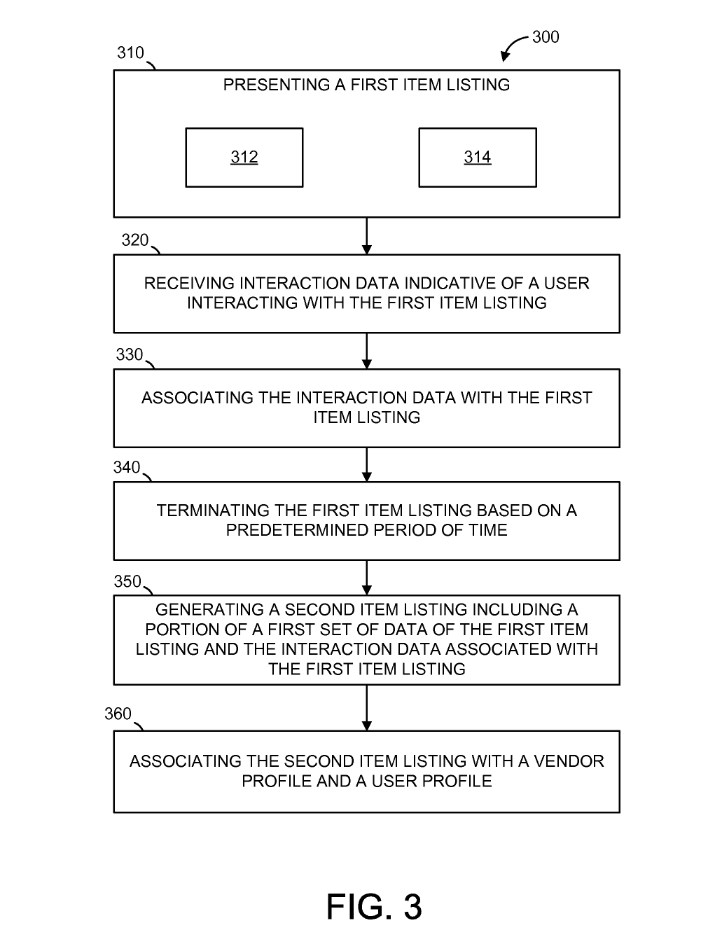

FIG. 3 is a flowchart illustrating operations of the server machine 110 in performing a method 300 of linking open offers and negotiation histories of two or more transactions, according to some example embodiments. Operations in the method 300 may be performed by the server machine 110, using modules described above with respect to FIG. 2.

In operation 310, the listing module 210 of the server machine 110 presents a first item listing. The first item listing can include at least a portion of a first set of data indicative of a product. The item listing can include information relating to the product, such as manufacturer information, make, model, style, color, specifications, combinations thereof, and other descriptive elements. The item listing can also contain information relating to the sale of the product, such as a purchase price, a bid amount, a reserve price, a quantity, availability, a warranty, delivery options, combinations thereof, and other information relating to the sale of the product. As discussed herein, the listing module 210 can be a hardware module configured to perform the operation 310 and additional related sub-operations.

In some embodiments, the operation 310 can include additional sub-operations. For example, the operation 310 can include operation 312 in which the server machine 110 receives the first set of data indicative of the product. In some embodiments, the server machine 110 can receive the first set of data from a vendor attempting to sell the product associated with the first set of data. The operation 310 can also include operation 314 in which the server machine 110 generates the first item listing from at least a portion of the first set of data.

In generating the first item listing, the generation module 250 of the server machine 110 can generate a first item identification for the first item listing, associate data indicative of the first item listing with the item identification for the first item listing, and associate the first item listing and the first item identification with a vendor profile of the vendor submitting the first set of data. Once the first item listing has been generated, the server machine 110 can store the first item listing in a database 125. For example, where the server machine 110 is a separate system from the publication system 120, the server machine 110 can transmit the first item listing and the intended association between the first item listing and the vendor profile to the publication system 120. Once received through the web server 114, the publication system 120 can store the first item listing in the database 125. For example, the publication system 120 can store the first item listing in a table, relational database, or other suitable data structure within the database 125. The data structure into which the first item listing is stored can include additional item listings from other vendors. The first item listing can be stored within the data structure in a defined manner. For example, the server machine 110 or the publication system 120 can determine one or more categories and subcategories into which the first item listing can be categorized. The first item listing can thereby be stored within a hierarchical order within the data structure of the database 125, having associations, indications, metadata, or other data indicating a position within the data structure.

In some embodiments, the publication system 120 can also store the association of the first item listing and the vendor profile in the database 125. For example, the first item listing can include an indicator, pointer, or other link to the associated vendor profile when both are stored within the database 125. In some embodiments, the indicator, pointer, or other link can be inserted into the first item listing. In some embodiments, the indicator, pointer, or other link can be located in metadata associated with the first item listing.

In operation 320, the interaction module 220 of the server machine 110 receives interaction data indicative of a user 132 or 142 interacting with the first item listing. The interaction data can include offers for purchase of an item listing, a bid for the item listing, placing the item listing on a watch list, viewing the item listing, sending a message to a vendor associated with the item listing, or other interactions with item listings of the publication system 120. The interaction data can be in the form of a set of data representing an action or a request for an action from the server machine 110 or the publication system 120. For example, the interaction data can be a hypertext transfer protocol (HTTP) request, a data packet, or any other suitable set of data capable of communicating the interaction with the interaction module 220.

In some embodiments, the interaction data includes an offer of a user 132 or 142 for purchase of the product. For example, the offer included in the interaction data can be a first offer from the user 132 and can include data indicating the user 132, a user profile of the user 132, the vendor, the vendor profile, the item identification of the first item listing, and other information. The interaction data can also include data for transmitting the interaction data to one or more of the server machine 110 and the publication system 120, such as header information (e.g., TCP/IP header). The first offer may be below a purchase price indicated by the first item listing, where the purchase price is indicated within the first item listing. In some example embodiments, the interaction data can comprise designation of the first item listing on a watch list associated with a user profile. For example, the interaction module 220 can be configured to associate the first item listing with the user profile indicating interest by the user 132 associated with the user profile. The watch list can comprise item listings or data representative of item listings (e.g., a uniform resource locator address) with which the user 132 has interacted and indicated a desire to revisit or some other interest. As noted above, in some embodiments, the interaction module 220 of the server machine 110, or an interaction module 220 of the publication system 120, can receive the interaction data indicative of the user 132 interacting with the first item listing. As discussed herein, the interaction module 220 can be a hardware module configured to perform the operation 320 and additional related sub-operations.

The interaction module 220 can receive the interaction data from the user device 130 via the network 150, with the server machine 110 acting as an intermediary between the user device 130 and the publication system 120. In some embodiments, the server machine 110 can be a part of the publication system 120 and can receive the interaction data through the publication system 120. In some further embodiments, the server machine 110 can receive a copy of the interaction data, with another copy being transmitted to the publication system 120. Further, in some embodiments, the publication system 120 can receive the interaction data from the user device 130 without interaction with the server machine 110.

In some embodiments, the interaction data can include a plurality of transmissions between the user device 130, the server machine 110 or publication system 120, and the vendor, so as to embody a negotiation between the user 132 and the vendor. For example, as will be explained in more detail below, the interaction data can include first interaction data, second interaction data, and third interaction data. The first interaction data can include the first offer, the second interaction data can include a counter offer from the vendor, and the third interaction data can include a second offer from the user 132. Each subsequent interaction data transmission (e.g., the first interaction data, the second interaction data, and the third interaction data) can include information relating prior interaction data transmissions. For example, as will be explained in more detail below, the interaction data can include a negotiation history, based on the server machine 110 or the publication system 120 receiving the first offer.

The interaction data can further include a completion indicator indicative of a status of the negotiation history. For example, the completion indicator can include a value indicative of either the user 132 or the vendor accepting an offer included in the previous interaction data transmission. By way of another example, the completion indicator can include a termination value. In some embodiments, where the publication system 120 enables a predetermined number of offers and counter offers, the termination value can be a value indicative of the total number of offers and counter offers or a total number of the offers or counter offers of each respective party to the negotiation. The termination value can have a predetermined limit, such that when the termination value reaches the predetermined number of offers and counter offers, the completion indicator can indicate the status of the negotiation history as failed and terminate further interaction data transmissions within a string of interaction data transmissions.

In operation 330, the interaction module 220 of the server machine 110 associates the interaction data with the first item listing. For example, the interaction module 220 can store all or at least a portion of the interaction data within the item listing. In some embodiments, the interaction module 220 associating the interaction data with the first item listing can be an interaction module 220 of the publication system 120. The interaction module 220, or the interaction module 220 of the publication system 120, can be a hardware module configured to associate the interaction data with the first item listing.

Where the interaction module 220 of the server machine 110 has access to the data structure in which the first item listing is stored, the interaction module 220 can store at least a portion of the interaction data within the item listing. For example, the set of data comprising the first item listing can be configured to contain an interaction data set to which the interaction module 220 can write at least a portion of the interaction data. In some embodiments, the interaction module 220 can transmit all or a portion of the interaction data to the publication system 120, where the first item listing is stored in the database 125. In these embodiments, the publication system 120 can store at least a portion of the interaction data within the first item listing.

The interaction module 220 of the server machine 110, directly or through the publication system 120, can store the interaction data as a separate set of interaction data. The interaction module 220, or the publication system 120, may then associate the first item listing and the set of interaction data. For example, each of the first item listing and the set of interaction data can be embodied by a file, or other collection of data, stored in a data structure. In associating the first item listing and the set of interaction data, the interaction module 220, or the publication system 120, can include, in each of the first item listing and the set of interaction data, a pointer, link, metadata, a memory location, an IP address, or other set of data to establish the association of the first item listing and the set of interaction data.

In operation 340, the termination module 230 of the server machine 110 terminates the first item listing based on a predetermined period of time. For example, the first item listing can include a predetermined period of time (e.g. a five day listing, a twenty-four hour listing, a month listing) indicating a time duration during which the first item listing will be active and the product available for purchase. The termination module 230, or the publication system 120, can determine when the predetermined period of time has elapsed, such as through the use of a decrementing counter or a system clock. Once the termination module 230, or the publication system 120, determines that the predetermined period of time has elapsed, the termination module 230 can terminate the first item listing, such as by deleting the listing or a portion of the listing from the database 125. In some embodiments, the first listing can be terminated (e.g., removed from the publication system 120 so as to no longer be visible to users 132, 142) by removing the item identification of the first item listing, while retaining the first item listing, or a portion thereof, within the database 125. The termination module 230 of the server machine 110, or a termination module 230 of the publication system 120 performing similar functions, can be a hardware module configured to terminate the first item listing based on the predetermined time period.

In operation 350, the generation module 250 of the server machine 110 generates a second item listing. The second item listing can include the portion of the first set of data of the first item listing and the interaction data associated with the first item listing. For example, in some embodiments, the generation module 250, or the publication system 120, can remove the item identification of the first item listing and replace that item identification with an item identification of the second item listing. In some embodiments, the second item listing can replace the first item listing by overwriting all or a portion of the data contained in the first item listing. In some embodiments, the generation module 250 of the server machine 110, or a generation module 250 of the publication system 120 performing similar functions, can be a hardware module configured to generate the second item listing.

In some example embodiments, the method 300 can further include operation 360. In operation 360, after termination of the first item listing and generation of the second item listing, the interaction module 220 associates the second item listing with one or more of the vendor profile and the user profile. The interaction module 220 can associate the second item listing with the vendor profile and the user profile, as well as the interaction data carried over from the association with the first item listing, by changing one or more values within the second item listing, within metadata associated with the second item listing, within the vendor profile and the user profile, or within metadata associated with the vendor profile and metadata associated with the user profile.

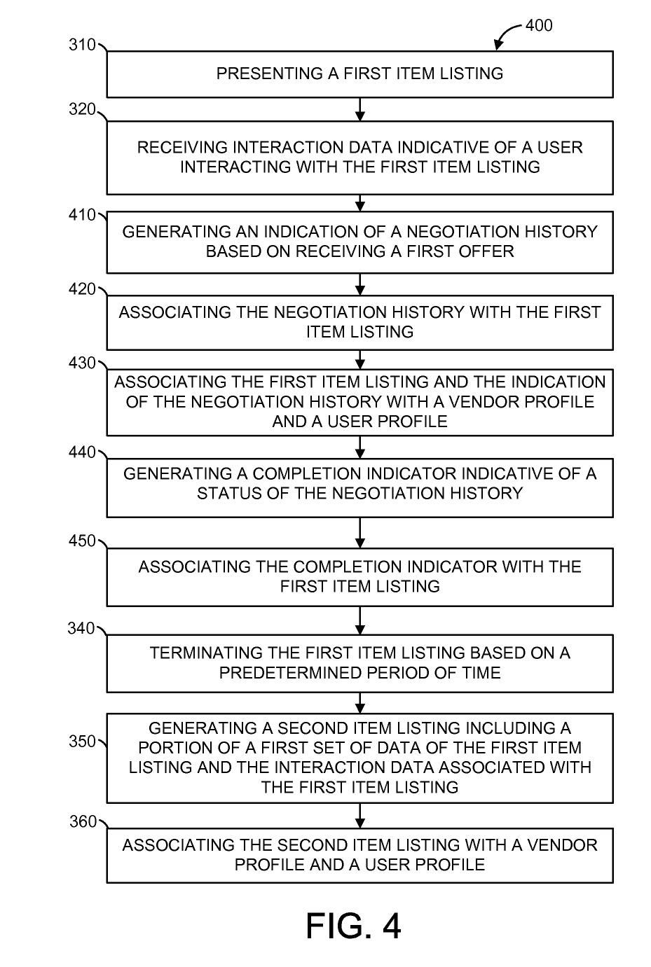

FIG. 4 is a flowchart illustrating operations of the server machine 110 in performing a method 400 of linking open offers and negotiation histories of two or more transactions, according to some example embodiment. Operations in the method 400 may be performed by the server machine 110, using modules described above with respect to FIG. 2. As shown in FIG. 4, the method 400 can include one or more of the operations of the method 300 shown in FIG. 3 and the common operations are not discussed in conjunction with FIG. 4.

In operation 410, the interaction module 220 of the server machine 110 generates a negotiation history. The negotiation history can include a set of data values representative of a negotiation between a buyer and a seller of for an item represented by the item listing. The set of data values for the negotiation history can include data representative of the existence of the negotiation, a value representative of whether the negotiation is open or completed, a value representative of a number of offers/counter offers allowed for the negotiation, a value representative of a number of offers/counter offers made, a value representative of a number of offers/counter offers available before the negotiation is completed, values representative of each offer/counter offer made during the course of the negotiation, and other suitable characteristics relating to the negotiation. The values representative of each offer/counter offer can include values representative of a monetary value of the offer/counter offer, a time the offer/counter offer was made, the user making the offer/counter offer, and any other suitable information capable of identifying the offer/counter offer. The negotiation history can include data values for a single party (e.g., the buyer) to the negotiation or data values for multiple parties (e.g., a buyer or multiple buyers and a vendor) to the negotiation. Initially, the negotiation history may be an incomplete negotiation history representative of an ongoing negotiation (e.g., an open negotiation).

The negotiation history can be generated based on receiving the first offer. For example, after the listing module 210 presents the first item listing in operation 310 and the interaction module 220 receives interaction data indicative of the first offer in operation 320, interaction module 220 can generate the negotiation history. The negotiation history can be represented by the set of data values stored in a data structure containing the first item listing. The negotiation history may also be represented by one or more values stored in metadata associated with the first item listing.

In operation 420, the interaction module 220 of the server machine 110 associates the negotiation history with the first item listing. After generating the negotiation history, in some example embodiments, the interaction module 220 can associate the negotiation history with the first item listing by changing one or more values within the first item listing or within metadata associated with the first item listing. The negotiation history may be associated with the first item listing in the same operation as the generation of the negotiation history, where the negotiation history is generated within the first item listing or in metadata previously associated with the first item listing. In some embodiments, the interaction module 220 can associate the negotiation history by passing the generated negotiation history to the listing module 210 to store the indication within the first item listing or metadata associated with the first item listing.

In operation 430, the listing module 210 of the server machine 110 associates the first item listing and the negotiation history with a vendor profile and a user profile. For example, the listing module 210 can receive the negotiation history or data representative of the negotiation history. The listing module 210 can then associate the first item listing and the negotiation history with the vendor profile by storing the negotiation history in metadata associated with both the vendor profile and the first item listing. For example, the listing module 210 may modify existing metadata associating the first item listing with the vendor profile to include the negotiation history. In some example embodiments, where the first item listing is associated with the vendor profile by one or more values represented by data included in the vendor profile, the listing module 210 can modify or otherwise include the negotiation history or data representative of the negotiation history into the vendor profile.

In operation 440, the interaction module 220 of the server machine 110 generates a completion indicator indicative of a status of the negotiation history. The completion indicator can be indicative of an incomplete negotiation history or a completed negotiation history. The completion indicator can be included within the negotiation history to indicate termination of the negotiation (e.g., a closed negotiation or a completed negotiation). Where the completion indicator expresses a completed negotiation history, the completion indicator can represent either a negotiation that has been completed successfully or a negotiation that results in a failure. For example, the completion indicator can be a value expressing a completed negotiation history, such as an acceptance of an offer by one of the vendor and the user 132. By way of further example, the completion indicator can be a value expressing a completed negotiation history for a failed negotiation by indicating a rejection of an offer by one of the vendor and the user 132, where the rejection concludes the negotiation.

The completion indicator can also indicate an incomplete negotiation history. For example, the completion indicator can be a value representing an offer transmitted by the user 132 to which the vendor has not yet responded. In some embodiments, the completion indicator can be initialized once an offer is received from the user 132 as a value or set of values initially representing an incomplete negotiation history. The completion indicator can be set as a default indicating the incomplete negotiation history. In this way, the negotiation history may be represented as incomplete until the interaction module 220 receives interaction data indicative of an acceptance or a final rejection of an offer by either the user 132 or the vendor. Subsequent communications between the user 132 and the vendor can be added to the incomplete negotiation history or overwritten on the value or set of values representing the incomplete negotiation history. However, until a completing action (e.g., a rejection concluding the negotiation or an acceptance of an offer) is received, the completion indicator may indicate the negotiation history is incomplete.

In operation 450, the interaction module 220 of the server machine 110 associates the completion indicator with the first item listing. The completion indicator may be associated with the first item listing within the negotiation history, within metadata associated with the first item listing, or within the first item listing.

In method 400, in some embodiments, including operation 340, the termination module 230 can terminate the first listing while the completion indicator indicates the incomplete negotiation history (e.g., an open negotiation or an ongoing negotiation).

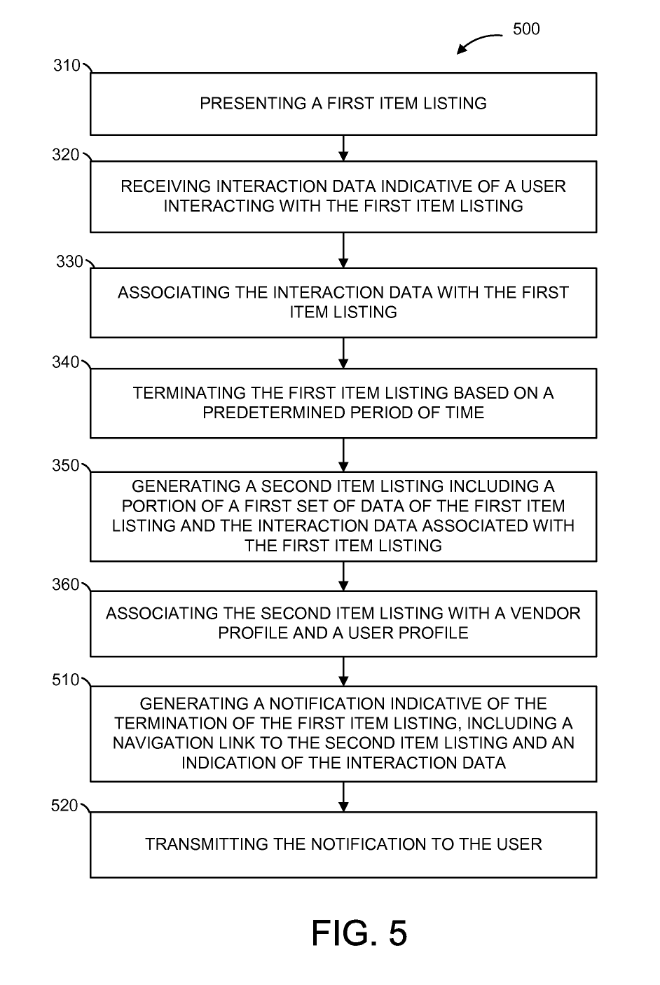

FIG. 5 is a flowchart illustrating operation of the server machine 110 in performing a method 500 of linking open offers and negotiation histories of two transactions. Operations in the method 500 may be performed by the server machine 110, using modules described above with respect to FIG. 2. As shown in FIG. 5, the method 500 can include one or more of the operations of the method 300 shown in FIG. 3 and the common operations are not discussed in conjunction with FIG. 4.

In operation 510, the notification module 260 of the server machine 110 generates a notification indicative of the termination of the first item listing. The notification can include a navigation link to the second item listing and an indication of the interaction data. In some example embodiments, where the notification module 260 generates the notification prior to the termination of the first item listing, the notification can include a navigation link to the first item listing and an indication of the interaction data. The navigation link can comprise a uniform resource locator for a webpage, such as a webpage generated by the publication system 120 and made available via the network 150. The indication of the interaction data can comprise the negotiation history, the status of the negotiation history, any offers included in the negotiation history, and an indication of any pending offers to which one or more of the vendor and the user 132 have not yet responded.

In operation 520, the notification module 260 transmits the notification to the user 132. For example, the notification module 260 can transmit the notification at a time proximate to the termination of the first item listing and the generation of the second item listing. In some example embodiments, the notification module 260 can transmit the notification prior to the termination of the first item listing, such as when the notification includes a navigation link to the first item listing. The notification may be transmitted to the user 132 and the vendor via the network 150 (e.g., via email), via the user profile and the vendor profile (e.g., published to the user profile and the vendor profile by the publication system 120), or any other suitable method.

According to various example embodiments, one or more of the methodologies described herein may facilitate finalizing purchase actions for item listings within the publication system 120, which may not otherwise have been completed. These methodologies can also facilitate interactions between users 132, 142 and vendors associated with the publication system 120. One or more of the methodologies described herein may obviate a need for certain efforts or resources that otherwise would be involved in locating items of interest in time delimited transactions on the publication system 120. Efforts expended by a user 132, 142 in finding vendors or items for sale by vendors may be similarly reduced by one or more of the methodologies described herein. Computing resources used by one or more machines, databases 125, or devices (e.g., within the network environment 100) associated with the efforts of users 132, 142 may similarly be reduced. Examples of such computing resources include processor cycles, network traffic, memory usage, data storage capacity, power consumption, and cooling capacity.

FIG. 6 is a block diagram illustrating components of a machine 600, according to some example embodiments, able to read instructions 624 from a machine-readable medium 622 (e.g., a non-transitory machine-readable medium, a machine-readable storage medium, a computer-readable storage medium, or any suitable combination thereof) and perform any one or more of the methodologies discussed herein, in whole or in part. Specifically, FIG. 6 shows the machine 600 in the example form of a computer system (e.g., a computer) within which the instructions 624 (e.g., software, a program, an application, an applet, an app, or other executable code) for causing the machine 600 to perform any one or more of the methodologies discussed herein may be executed, in whole or in part.

As noted above, the machine 600 can represent an implementation of the systems described above. For instance, the server machine 110 and the publication system 120 can be implemented similarly to or the same as the machine 600 described below. In embodiments where the server machine 110 is included as a portion of the publication system 120, the server machine 110 and the publication system 120 can both be implemented as the same machine 600. In some embodiments, where the machine 600 represents an implementation of the server machine 110, the server machine 110 can perform part or all of the operations discussed above with respect to FIGS. 3, 4, and 5. For example, the machine 600, acting as an implementation of the server machine 110 can perform operations 310-360 of the method 300, described above with respect to FIG. 3.

In alternative embodiments, the machine 600 operates as a standalone device or may be communicatively coupled (e.g., networked) to other machines. In a networked deployment, the machine 600 may operate in the capacity of a server machine 110 or a client machine in a server-client network environment, or as a peer machine in a distributed (e.g., peer-to-peer) network environment 100. The machine 600 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 624, sequentially or otherwise, that specify actions to be taken by that machine. Further, while only a single machine 600 is illustrated, the term “machine” shall also be taken to include any collection of machines 600 that individually or jointly execute the instructions 624 to perform all or part of any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, a cathode ray tube (CRT), or any other display capable of displaying graphics or video). The machine 600 may also include an alphanumeric input device 612 (e.g., a keyboard or keypad), a cursor control device 614 (e.g., a mouse, a touchpad, a trackball, a joystick, a motion sensor, an eye tracking device, or other pointing instrument), a storage unit 616, an audio signal generation device 618 (e.g., a sound card, an amplifier, a speaker, a headphone jack, or any suitable combination thereof), and a network interface device 620.

The storage unit 616 includes the machine-readable medium 622 (e.g., a tangible and non-transitory machine-readable storage medium) on which are stored the instructions 624 embodying any one or more of the methodologies or functions described herein. The instructions 624 may also reside, completely or at least partially, within the main memory 604, within the processor 602 (e.g., within the processor 602′s cache memory), or both, before or during execution thereof by the machine 600. Accordingly, the main memory 604 and the processor 602 may be considered machine-readable media 622 (e.g., tangible and non-transitory machine-readable media 622). The instructions 624 may be transmitted or received over the network 150 via the network interface device 620. For example, the network interface device 620 may communicate the instructions 624 using any one or more transfer protocols (e.g., hypertext transfer protocol (HTTP)). In some embodiments, the machine-readable medium 622 can store the item listings, interaction data, negotiation histories, and user profiles discussed above.

In some example embodiments, the machine 600 may be a portable computing device, such as a smart phone or tablet computer, and have one or more additional input components 628 (e.g., sensors or gauges). Examples of such input components 628 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 628 may be accessible and available for use by any of the modules described herein.

As used herein, the term “memory” refers to a machine-readable medium 622 able to store data temporarily or permanently and may be taken to include, but not be limited to, random-access memory (RAM), read-only memory (ROM), buffer memory, flash memory, and cache memory. While the machine-readable medium 622 is shown, in an example embodiment, to be a single medium, the term “machine-readable medium” should be taken to include a single medium or multiple media (e.g., a centralized or distributed database, or associated caches and servers) able to store instructions 624. The term “machine-readable medium” shall also be taken to include any medium, or combination of multiple media, that is capable of storing the instructions 624 for execution by the machine 600, such that the instructions 624, when executed by one or more processors of the machine 600 (e.g., processor 602), cause the machine 600 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

FIG. 7 is a block diagram illustrating a mobile device 700, according to some example embodiments. For example, the mobile device 700 may be an implementation of the user device 130 or 140. In some embodiments, the mobile device 700, in communication with the server machine 110, can perform some of the methodologies described herein, and can provide input from the user 132 or 142 to the server machine 110. For example, the mobile device 700, representing an implementation of the user device 130 or 140, can receive the first item listing, the presentation of which may be caused by the server machine 110 in operation 310 of the method 300. In some instances, the mobile device 700 can receive input from the user 132 or 142, generating one or more user interrupts representative of the interaction data of the user which may cause the transmission of the interaction data to be received by the interaction module 220 in operation 320 of method 300, described in FIG. 3. Further, the mobile device 700, representing an implementation of the user device 130 or 140, can receive the notification transmitted in operation 520 of the method 500, discussed in FIG. 5.

The mobile device 700 can include a processor 702. The processor 702 can be any of a variety of different types of commercially available processors suitable for mobile devices 700 (for example, an XScale architecture microprocessor, a microprocessor without interlocked pipeline stages (MIPS) architecture processor, or another type of processor). A memory 704, such as a random access memory (RAM), a Flash memory, or other type of memory, is typically accessible to the processor 702. The memory 704 can be adapted to store an operating system (OS) 706, as well as application programs 708, such as a mobile location enabled application that can provide location based services to a user 132, 142. The processor 702 can be coupled, either directly or via appropriate intermediary hardware, to a display 710 and to one or more input/output (I/O) devices 712, such as a keypad, a touch panel sensor, a microphone, and the like. Similarly, in some example embodiments, the processor 702 can be coupled to a transceiver 714 that interfaces with an antenna 716. The transceiver 714 can be configured to both transmit and receive cellular network signals, wireless data signals, or other types of signals via the antenna 716, depending on the nature of the mobile device 700. Further, in some configurations, a GPS receiver 718 can also make use of the antenna 716 to receive GPS signals.

The mobile device 700 can be configured to perform any one or more of the methodologies discussed herein. For example, the memory 704 of the mobile device 700 may include instructions 624 comprising one or more of the receiver module, the generation module 250, the identification module, the organization module, and the presentation module. The modules can configure the processor 702 of the mobile device 700 to perform one or more of the operations outlined above with respect to each module. In some embodiments, the mobile device 700 and the machine 600 can each store at least a portion of the modules discussed above and cooperate to perform the methods described above, as will be explained in more detail below.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 622 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 702 or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 702 or other programmable processor 702. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 702 configured by software to become a special-purpose processor, the general-purpose processor 702 may be configured as respectively different special-purpose processors (e.g., comprising different hardware modules) at different times. Software (e.g., a software module) may accordingly configure one or more processors 702, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 608) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions described herein. As used herein, “processor-implemented module” refers to a hardware module implemented using one or more processors 702.

Similarly, the methods described herein may be at least partially processor-implemented, a processor 702 being an example of hardware. For example, at least some of the operations of a method may be performed by one or more processors 702 or processor-implemented modules. As used herein, “processor-implemented module” refers to a hardware module in which the hardware includes one or more processors 702. Moreover, the one or more processors may also operate to support performance of the relevant operations in a “cloud computing” environment or as a “software as a service” (SaaS). For example, at least some of the operations may be performed by a group of computers (as examples of machines 600 including processors 702), with these operations being accessible via a network 626 (e.g., the Internet) and via one or more appropriate interfaces (e.g., an application program interface (API)).

The performance of certain operations may be distributed among the one or more processors 702, not only residing within a single machine 600, but deployed across a number of machines 600. In some example embodiments, the one or more processors 702 or processor-implemented modules may be located in a single geographic location (e.g., within a home environment, an office environment, or a server farm). In other example embodiments, the one or more processors 702 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 600. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 600 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system, comprising:
a listing module configured to present a first item listing, the first item listing including at least a portion of a first set of data indicative of a product;
an interaction module configured to receive interaction data indicative of a user interacting with the first item listing and to associate the interaction data with the first item listing, the interaction data including an offer of a user for purchase of the product;
a termination module configured to terminate the first item listing based on a predetermined period of time; and
a generation module configured to generate a second item listing including the portion of the first set of data included in the first item listing and the interaction data associated with the first item listing.

2. The system of claim 1, wherein at least a portion of the interaction data is a first offer from the user, the first offer being below a purchase price indicated by the first item listing.

3. The system of claim 2, wherein the interaction module is further configured to transmit a first counter offer from a vendor and to receive a second offer from the user, the first counter offer being below the purchase price and above the first offer, the second offer being below the purchase price and below the counter offer.

4. The system of claim 2, wherein the interaction module is further configured to generate a negotiation history, based on receiving the first offer, and to associate the negotiation history with the first item listing.

5. The system of claim 4, wherein the listing module is further configured to associate the first item listing and the negotiation history with a vendor profile and a user profile.

6. The system of claim 4, wherein the interaction module is further configured to generate a completion indicator indicative of a status of the negotiation history and to associate the completion indicator with the first item listing.

7. The system of claim 6, wherein the completion indicator is indicative of a completed negotiation history.

8. The system of claim 7, wherein the completion indicator is indicative of an acceptance of an offer by one of a vendor and the user.

9. The system of claim 7, wherein the completion indicator is indicative of a rejection of an offer by one of a vendor and the user, the rejection concluding the negotiation.

10. The system of claim 6, wherein the completion indicator is indicative of an incomplete negotiation history.

11. The system of claim 10, wherein the first item listing is terminated while the completion indicator indicates the incomplete negotiation history.

12. The system of claim 1, wherein the generation module is further configured to:
generate an item identification for the second item listing;
associate data indicative of the first item listing with the item identification for the second item listing; and
associate the interaction data with the item identification for the second item listing.

13. The system of claim 1 further comprising:
a notification module configured to generate a notification indicative of the termination of the first item listing, the notification including a navigation link to the second item listing and an indication of the interaction data, and to transmit the notification to the user at a time proximate to the termination of the first item listing and the generation of the second item listing.

14. The system of claim 13, wherein the notification module transmits the notification prior to the termination of the first item listing.

15. The system of claim 1, further comprising:
a notification module configured to generate a notification indicative of the termination of the first item listing, the notification including a navigation link to the first item listing and an indication of the interaction data, and to transmit the notification to the user prior to the termination of the first item listing.

16. The system of claim 1, wherein the interaction module is further configured to:
associate the interaction data with a user profile of the user;
based on the interaction data, associate the first item listing with the user profile; and
after termination of the first item listing and generation of the second item listing, associate the second item listing with the user profile.

17. A method, comprising:
presenting a first item listing, the first item listing including at least a portion of a first set of data indicative of a product;
receiving interaction data indicative of a user interacting with the first item listing, the interaction data including an offer of a user for purchase of the product;
associating the interaction data with the first item listing;
terminating the first item listing based on a predetermined period of time; and
generating a second item listing including the portion of the first set of data of the first item listing and the interaction data associated with the first item listing.

18. The method of claim 17, further comprising:
generating a notification indicative of the termination of the first item listing, the notification including a navigation link to the second item listing and an indication of the interaction data, and to transmit the notification to the user at a time proximate to the termination of the first item listing and the generation of the second item listing.

19. A non-transitory machine-readable storage medium comprising processor executable instructions that, when executed by a processor of a machine, cause the machine to perform operations comprising:
presenting a first item listing, the first item listing including at least a portion of a first set of data indicative of a product;
receiving interaction data indicative of a user interacting with the first item listing, the interaction data including an offer of a user for purchase of the product;
associating the interaction data with the first item listing;
terminating the first item listing based on a predetermined period of time; and
generating a second item listing including the portion of the first set of data of the first item listing and the interaction data associated with the first item listing.

20. The non-transitory machine-readable storage medium of claim 19, wherein the processor executable instructions further cause a processor of the machine to perform operations comprising:
generating a notification indicative of the termination of the first item listing, the notification including a navigation link to the second item listing and an indication of the interaction data, and to transmit the notification to the user at a time proximate to the termination of the first item listing and the generation of the second item listing.
